(19) United States
(12) Patent Application Publication
(10) Pub. No.: US 2015/0022727 A1
(43) Pub. Date: Jan. 22, 2015

(54) TILEABLE DISPLAY APPARATUS

(71) Applicant: Google Inc., Mountain View, CA (US)

(72) Inventor: Mary Lou Jepsen, Sausalito, CA (US)

(73) Assignee: Google Inc., Mountain View, CA (US)

(21) Appl. No.: 14/144,998

(22) Filed: Dec. 31, 2013

Related U.S. Application Data
(60) Provisional application No. 61/856,458, filed on Jul. 19, 2013.

(51) Int. Cl. G02F 1/1333

(52) U.S. Cl. CPC G02F 1/13336
USPC 349/5

(57) ABSTRACT

A display apparatus includes a screen layer, an illumination layer, and a display layer. The screen layer is for displaying a unified image to a viewer on a viewing side of the screen layer. The illumination layer includes an array of light sources and each light source in the array is configured to emit a divergent projection beam having a limited angular spread. The display layer is disposed between the screen layer and the illumination layer. The display layer includes a matrix of pixelets and a spacing region disposed between the pixelets in the matrix. The array of light sources are positioned to emit the divergent projection beams having limited angular spread to project sub-images displayed by the pixelets as magnified sub-images on the backside of the screen layer. The magnified sub-images combine to form the unified image that is substantially seamless.

### CROSS-REFERENCE TO RELATED APPLICATIONS

This application claims priority under the provisions of 35 U.S.C. §119(e) to U.S. Provisional Application No. 61/856,458 filed Jul. 19, 2013.

### TECHNICAL FIELD

This disclosure relates generally to displays, and in particular but not exclusively, relates to tileable displays.

### BACKGROUND INFORMATION

Large displays can be prohibitively expensive as the cost to manufacture display panels rises exponentially with display area. This exponential rise in cost arises from the increased complexity of large monolithic displays, the decrease in yields associated with large displays (a greater number of components must be defect free for large displays), and increased shipping, delivery, and setup costs. Tiling smaller display panels to form larger multi-panel displays can help reduce many of the costs associated with large monolithic displays.

Tiling multiple smaller, less expensive display panels together can achieve a large multi-panel display, which may be used as a large wall display. The individual images displayed by each display panel may constitute a sub-portion of the larger overall-image collectively displayed by the multi-panel display. While a multi-panel display can reduce costs, visually it has a major drawback. Specifically, bezel regions that surround the displays put seams or cracks in the overall-image displayed by the multi-panel display. These seams are distracting to viewers and detract from the overall visual experience. Furthermore, when many high-resolution displays are used to make a large multi-panel display, the overall-image is extremely high resolution, which creates bandwidth and processing challenges for driving image content (especially video) to the extremely high resolution display.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIGS. 1A-1C illustrate a display apparatus that includes a display layer disposed between a screen layer and an illumination layer, in accordance with an embodiment of the disclosure.

FIG. 2 shows a semi-transparent plan view of a display apparatus looking through a screen layer to a display layer, in accordance with an embodiment of the disclosure.

FIG. 3 shows more than one display apparatus tiled together to form a tiled display, in accordance with an embodiment of the disclosure.

### DETAILED DESCRIPTION

Embodiments of an apparatus and a system of tileable displays is described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

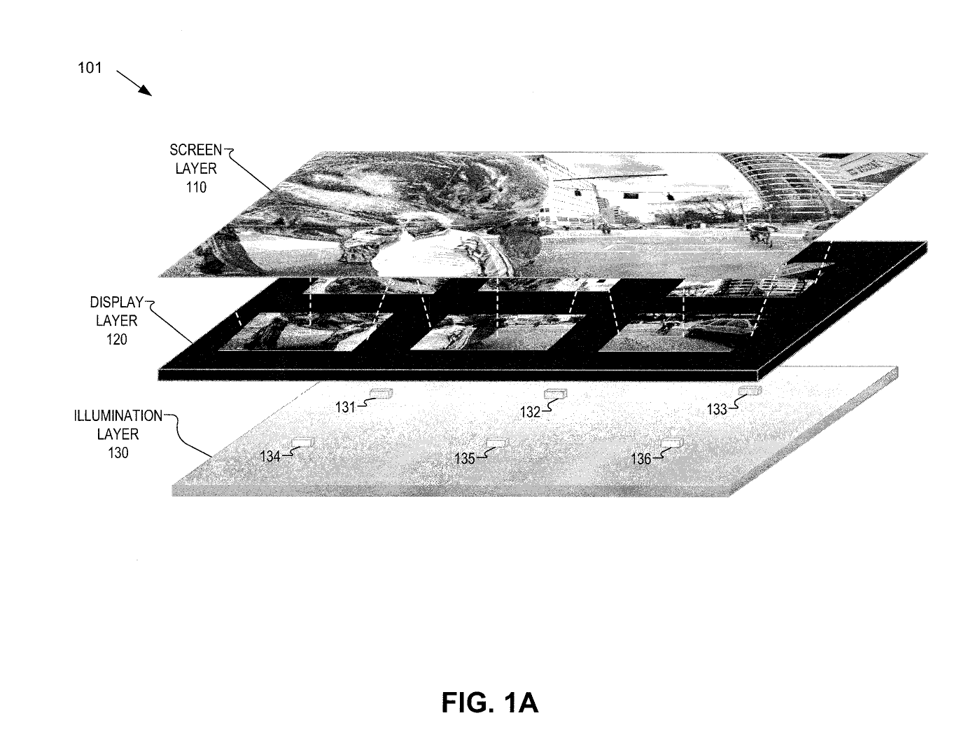

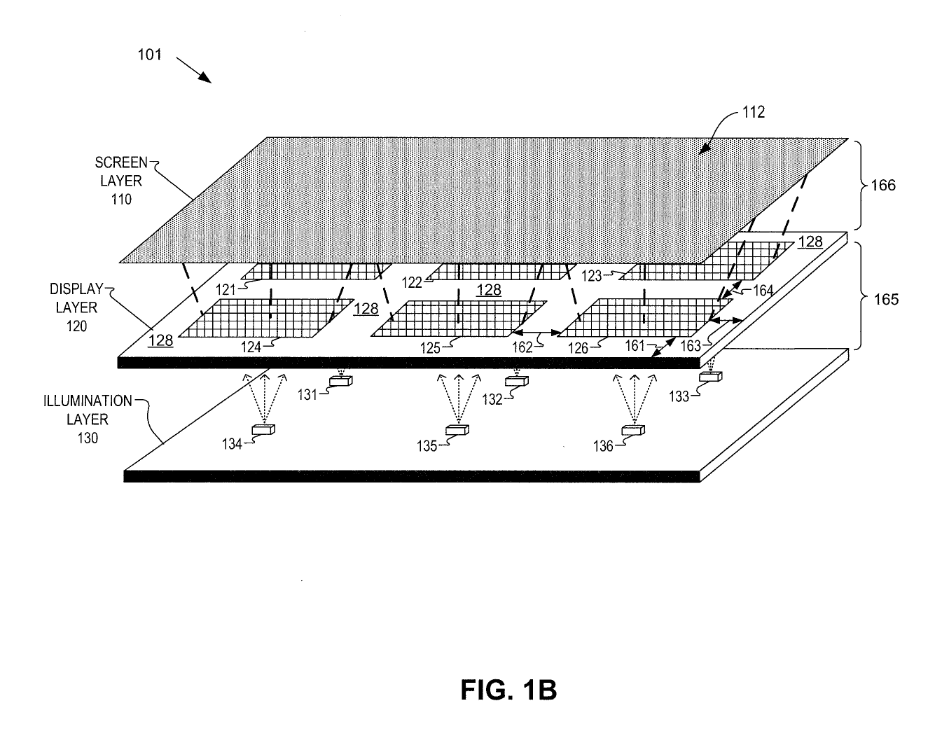

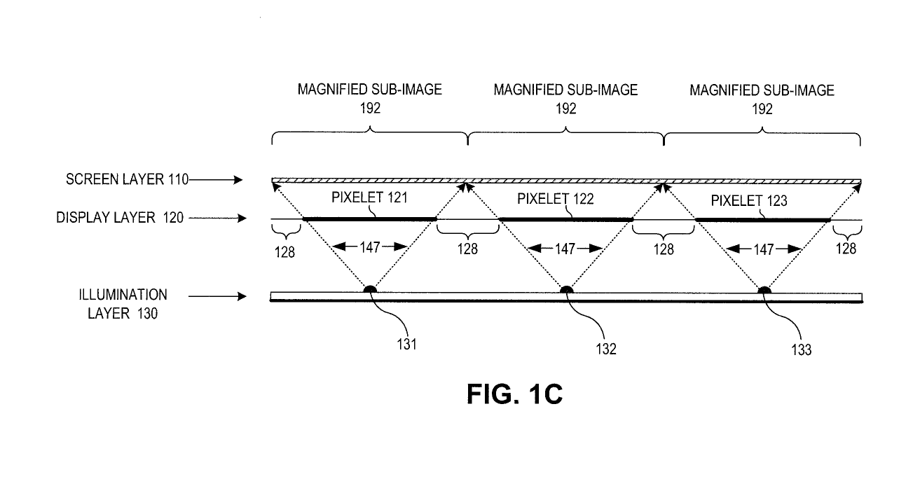

FIGS. 1A-1C illustrate a display apparatus 101 that includes a display layer 120 disposed between a screen layer 110 and an illumination layer 130, in accordance with an embodiment of the disclosure. FIG. 1A shows that illumination layer 130 includes an array light sources 131, 132, 133, 134, 135, and 136. Each light source in the array of light sources illuminates a corresponding pixelet to project the sub-image of the pixelet onto the screen layer 110 as a unified image. In the embodiment illustrated in FIG. 1A, each pixelet includes a transmissive pixel array arranged in rows and columns (e.g. 100 pixels by 100 pixels).

FIG. 1B includes additional number references for the purpose of a more detailed discussion of display apparatus 101. FIG. 1B also shows illumination layer 130 including light sources 131, 132, 133, 134, 135, and 136. In the illustrated embodiment, each light source is disposed on a common plane of illumination layer 130. In one embodiment, each light source is a laser. In one embodiment, each light source is a light-emitting-diode (“LED”) that emits light from a relatively small emission aperture. For example, LEDs with an emission aperture of 150-300 microns may be used. The LED may emit white light. Other technologies may be used as light sources. In one embodiment, each light source is an aperture emitting light from a light integration cavity shared by at least one other light source.

Display layer 120 includes a matrix of pixelets 121, 122, 123, 124, 125, and 126. In the illustrated embodiment, each pixelet in the matrix of pixelets is oriented on a common plane of display layer 120. The pixelets may be liquid-crystal-displays (“LCDs”) that can be color LCDs or monochromatic LCDs. The pixelets may utilize other spatial light modulator technologies. In one embodiment, each pixelet is an independent display array separated by spacing region 128 on display layer 120. In one embodiment, each pixelet measures 20×20 mm. FIG. 1B shows a 2×3 matrix of pixelets 121-126. The pitch between each pixelet in the matrix may be the same. In other words, the distance between a center of one pixelet and the center of its adjacent pixelets may be the same distance. In the illustrated embodiment, each light source in the array of light sources has a one-to-one correspondence with a pixelet. For example, light source 131 corresponds to pixelet 121, light source 132 corresponds to pixelet 122, light source 133 corresponds to pixelet 123, and so on. Also in the illustrated embodiment, each light source is centered under its respective corresponding pixelet.

Each light source 131-136 is configured to emit a divergent projection beam 147 having a limited angular spread that is directed toward a specific corresponding pixelet in display layer 120, as illustrated in FIG. 1C. In an embodiment, divergent projection beam 147 may be substantially shaped as a cone (circular aperture) or an inverted pyramid (rectangle/square aperture). Additional optics may be disposed over each light source in the array of light sources to define the limited angular spread (e.g. 20-70 degrees) and/or cross-sectional shape of divergent projection beam 147 emitted from the light sources. The additional optics (including refractive and/or diffractive optics) may also increase brightness uniformity of the display light in divergent projection beam 147 so that the intensity of divergent projection beam 147 incident upon each pixel in a given pixelet is substantially similar.

In some embodiments (not illustrated in FIG. 1C), divergent projection beams 147 from different light sources may overlap upon the spacing region 128 on the backside of display layer 120. In some embodiments, each pixelet is directly illuminated solely by one divergent projection beam from its corresponding light source, which may approximate a point source. In certain embodiments, a very small percentage of light from non-corresponding light sources may become indirectly incident upon a pixelet due to unabsorbed reflections of divergent projection beams 147 from the non-corresponding light sources. Spacing regions 128 and illumination layer 130 may be coated with light absorption coatings (that are known in the art) to decrease reflections from non-corresponding light sources from eventually becoming incident upon a pixelet that does not correspond with the light source. The limited angular spread of the light sources may be designed to ensure that divergent projection beams 147 only directly illuminates the pixelet that corresponds to a particular light source. In contrast, conventional LCD technology utilizes lamps (e.g. LEDs or cold-cathode-fluorescents) with a generally Lambertian light distribution and diffusive filters in an attempt to generate uniform and diffuse light for backlighting an LCD panel.

Referring back to FIG. 1B, display layer 120 also includes spacing region 128 surrounding pixelets 121-126. In FIG. 1B, pixelet 126 is adjacent to pixelets 123 and 125. Pixelet 126 is spaced by dimension 162 from pixelet 125 and spaced by dimension 164 from pixelet 123. Dimensions 162 and 164 may be considered “internal spacing” and are the same distance, in some embodiments. Pixelet 126 is also spaced by dimensions 161 and 163 from edges of display layer 120. Dimensions 161 and 163 may be considered “external spacing” and are the same distance, in some embodiments. In one embodiment, dimensions 161 and 163 are half of the distance as dimensions 162 and 164. In one example, dimensions 161 and 163 are both 2 mm and dimensions 162 and 164 are both 4 mm. In the illustrated embodiment, the internal spacing between pixelets is substantially greater than the pixel pitch (space between pixels) of pixels included in each pixelet.

Spacing region 128 contains a backplane region that includes pixel logic for driving the pixels in the pixelets. One potential advantage of the architecture of display apparatus 101 is increasing space for additional circuitry in the backplane region. In one embodiment, the backplane region is used for memory-in-pixel logic. Giving the pixels memory may allow each pixel to be refreshed individually instead of refreshing each pixel in a row at every refresh interval (e.g. 60 frames per second). In one embodiment, the backplane region is used to assist in imaging processing. When display apparatus 101 is used in high-resolution large format displays, the additional image processing capacity will be useful for image signal processing, for example dividing an image into sub-images that are displayed by the pixelets. In another embodiment, the backplane region is used to embed image sensors. In one embodiment, the backplane region includes infrared image sensors for sensing 3D scene data in the display apparatus' environment.

In operation, display light in a divergent projection beam 147 from a light source (e.g. light source 131) propagates toward its corresponding pixelet (e.g. pixelet 121). Each pixelet drives their pixels to display a sub-image on the pixelet so the display light that propagates through the pixelet includes the sub-image displayed by the pixelet. Since the light source generates the divergent projection beam 147 from a small aperture and the divergent projection beam 147 has a limited angular spread, the sub-image in the display light gets larger as it gets further away from the pixelet. Therefore, when the display light (including the sub-image) encounters screen layer 110, a magnified version of the sub-image is projected onto a backside of screen layer 110.

Screen layer 110 is offset from pixelets 121-126 by a fixed distance 166 to allow the sub-images to become larger as the display light (in divergent projection beams 147) propagates further from the pixelet that drove the sub-image. Therefore, the fixed distance 166 will be one component of how large the magnification of the sub-images is. In one embodiment, fixed distance 166 is 2 mm. In one embodiment, each sub-image generated by pixelets 121-126 is magnified by 1.5×. In some embodiments each sub-image generated by each pixelets 121-126 is magnified by 1.05-1.25×. The offset by fixed distance 166 may be achieved by using a transparent intermediary (e.g. glass or plastic layers). In one embodiment, screen layer 110 is fabricated of a matte material suitable for rear projection that is coated onto a transparent substrate that provides the offset by fixed distance 166.

The backside of screen layer 110 is opposite a viewing side 112 of screen layer 110. Screen layer 110 may be made of a diffusion screen that presents the unified image on the viewing side 112 of screen layer 110 by scattering the display light in the divergent projection beams 147 (that includes the sub-images) from each of the pixelets 121-126. Screen layer 110 may be similar to those used in rear-projection systems.

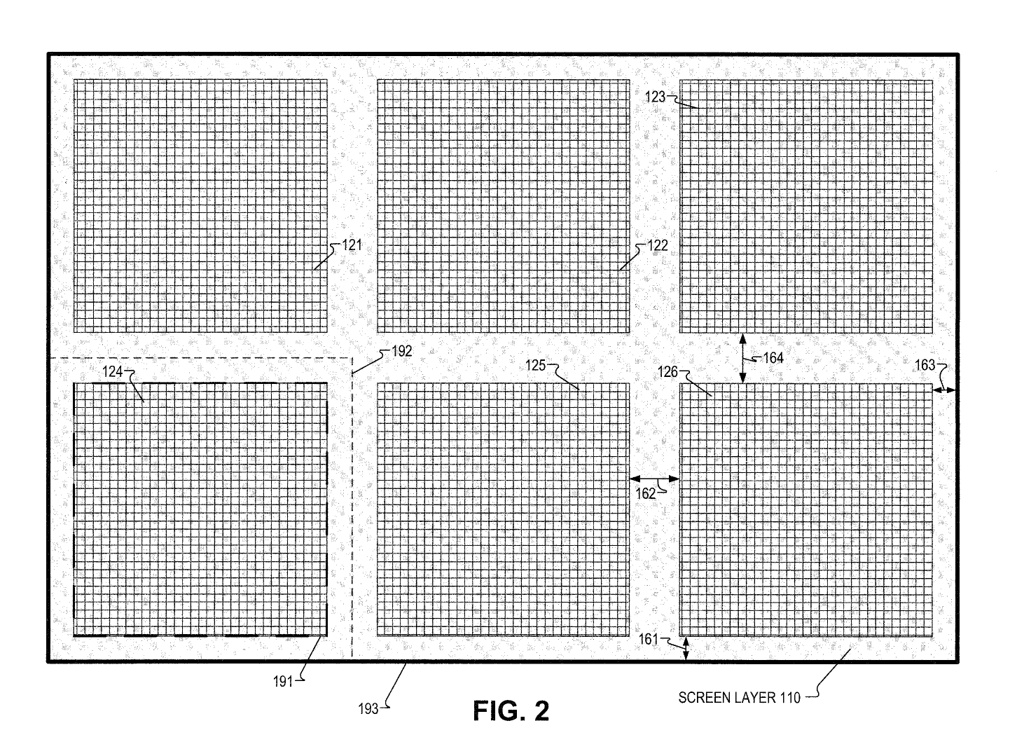

FIG. 2 shows a semi-transparent plan view of display apparatus 101 looking through screen layer 110 to display layer 120, in accordance with an embodiment of the disclosure. FIG. 2 shows how the display apparatus can generate a unified image 193 using the magnified sub-images 192 generated by light sources 131-136 and their corresponding pixelets 121-126. In FIG. 2, pixelet 124 generates a sub-image 191 that is projected (using the display light in the divergent projection beam 147 from light source 134) on screen layer 110 as magnified sub-image 192. Although not illustrated, each pixelet 121, 122, 123, 125, and 126 can also project a magnified sub-image onto the screen layer 110 that is the same size as magnified sub-image 192. Those five magnified sub-images combined with magnified sub-image 192 combine to form unified image 193. And, since the geometric alignment of the magnified sub-images would leave virtually no gap (if any) between the magnified sub-images, unified image 193 will be perceived as seamless by a viewer. FIG. 2 shows that the magnified sub-images on the backside of the screen layer 110 combine laterally to form unified image 193. The magnification of the sub-images allows the unified image to reach the edge of screen layer 110, while display layer 120 and illumination layer 130 may still include a mechanical bezel that offers rigidity and support for electrical connections that is out of sight to a viewer of display apparatus 101.

In FIG. 2, the magnified sub-images would each be the same size and be square-shaped. To generate same sized magnified sub-images, display layer 120 and its pixelets 121-126 may be offset from light sources 131-136 by a fixed dimension 165 (as shown in FIG. 1). In one embodiment, dimension 165 is 8 mm. While FIGS. 1A-1C do not illustrate intervening layers between the layers 110, 120, and 130, it should be appreciated that embodiments may include various intervening optical and structural layers, such as lens arrays, optical offsets, and transparent substrates to provide mechanical rigidity.

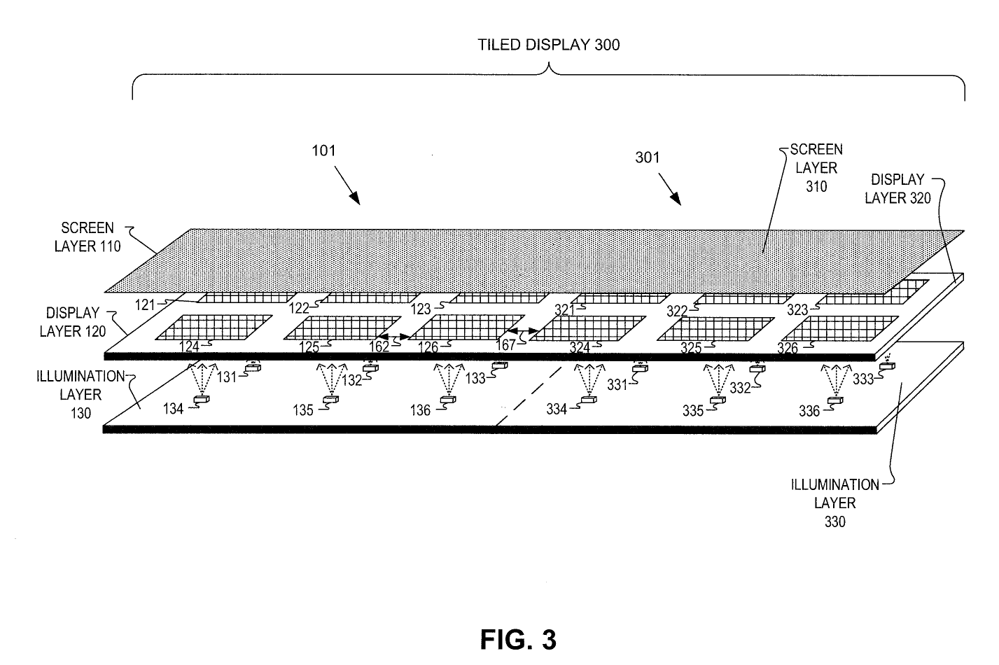

FIG. 3 shows display apparatus 101 and 301 tiled together to form a tiled display 300, in accordance with an embodiment of the disclosure. Tiled display 300 displays an overall-image that is a combination of a unified image (e.g. unified image 193) projected by display apparatus 101 and a unified image projected by display apparatus 301. In FIG. 3, display apparatus 301 is substantially the same as display apparatus 101 although different reference numbers are used for discussion purposes. It is understood that display apparatus 101 can be tiled together with other display apparatuses in a modular approach to building tiled display 300. In one embodiment, a self-healing adhesive is applied between screen layer 110 and screen layer 310. This adhesive will blend screen layer 110 and screen layer 310 to hide easily perceived seams between screen layers 110 and 310 in tiled display 300. In one embodiment, the self-healing adhesive is made of polymers.

In one embodiment, a monolithic screen layer is disposed over display layer 120 and 320 so that the screen layer does not have a seam. Monolithic screen layers with appropriate mechanical fixtures may be sized to common tiled arrangements of multiple display apparatus 101 (e.g. 2×2, 3×3, 4×4).

In FIG. 3, dimension 167 is the same distance as dimension 162. This maintains the pitch between the pixelets 126 and 324, as illustrated. Therefore, the edge of the magnified sub-image generated by light source 334 and pixelet 324 geometrically aligns with the edge of the magnified sub-image generated by light source 136 and pixelet 126. Similarly, the edge of the magnified sub-image generated by light source 331 and pixelet 321 geometrically aligns with the edge of the magnified sub-image generated by light source 133 and pixelet 123. In this way, the unified image projected on screen layer 310 aligns with the unified image projected on screen layer 110 as the overall-image displayed by tiled display 300.

Because the magnified sub-images (and therefore the unified images) of each display apparatuses 101 and 301 are aligned at their edges on screen layer 110/310, the pixel pitch and density of the overall-image can remain the same, even where display apparatus 101 and 301 are coupled together. Hence, where traditional tiled displays have a distracting bezel where two display layers are coupled together, tiled display 300 may have an unperceivable seam because of the near-seamless visual integration of the unified images as the overall-image on tiled display 300.

It is appreciated that a third and fourth display apparatus that are the same as display apparatus 101 could be added to tiled display 300 to form a larger tiled display that is a 2×2 matrix of display apparatus 101 and that the larger display could have the same potential advantages as explained in association with tiled display 300. Of course, displays larger than a 2×2 matrix may also be formed.

In some embodiments (not shown) mechanical structures may be added to each display apparatus 101 to facilitate the correct physical alignment of additional display apparatus. In one embodiment, electrical connectors that facilitate power and image signals are included in display apparatus 101 to facilitate modular construction of a tiled display using the display apparatus 101.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A display apparatus comprising:
a screen layer for displaying a unified image to a viewer on a viewing side of the screen layer that is opposite a backside of the screen layer;
an illumination layer having an array of light sources, wherein each light source in the array is configured to emit a divergent projection beam having a limited angular spread; and
a display layer disposed between the screen layer and the illumination layer, the display layer comprising:
a matrix of pixelets; and
a spacing region disposed between the pixelets in the matrix, wherein the array of light sources are positioned to emit the divergent projection beams having limited angular spread to project sub-images displayed by the pixelets as magnified sub-images on the backside of the screen layer, the magnified sub-images to combine to form the unified image that is substantially seamless.

2. The display apparatus of claim 1, wherein the pixelets are offset from the light sources in the array of light sources by a second fixed distance.

3. The display apparatus of claim 1, wherein an internal spacing between each adjacent pixelet in the matrix is a first dimension.

4. The display apparatus of claim 3, wherein an external spacing between edges of the display layer and edges of the pixelets is a second dimension that is half of the first dimension.

5. The display apparatus of claim 1, wherein each light source in the array of light sources has a one-to-one correspondence with a corresponding pixelet in the matrix of pixelets.

6. The display apparatus of claim 5, wherein each light source in the array is centered under its corresponding pixelet.

7. The display apparatus of claim 1, wherein at least a portion of the spacing region includes a backplane region that includes pixel logic for driving pixels in the pixelets.

8. The display apparatus of claim 7, wherein the pixel logic includes memory-in-pixel.

9. The display apparatus of claim 1, wherein the light sources in the array of light sources are at least one of lasers or light-emitting-diodes (“LEDs”).

10. The display apparatus of claim 1, wherein additional optics are disposed over the light sources in the array of light sources to define the limited angular spread of the divergent projection beam.

11. The display apparatus of claim 1, wherein each pixelet in the matrix is positioned to receive its divergent projection beam having limited angular spread from a corresponding light source in the array of light sources, but not positioned to receive the divergent projection beams from the light sources in the array of light sources that are other than the corresponding light source.

12. The display apparatus of claim 1, wherein the pixelets are offset from the screen layer by a fixed distance.

13. The display apparatus of claim 1, wherein the magnified sub-images on the backside of the display layer combine laterally to form the unified image.

14. The display apparatus of claim 1, wherein the divergent projection beams are substantially shaped as inverted pyramids.

15. A multi-panel display comprising:
a plurality of tileable displays arranged to form the multi-panel display, each tileable display comprising:
a screen layer for displaying a unified image to a viewer on a viewing side of the screen layer that is opposite a backside of the screen layer;
an illumination layer having an array of light sources, wherein each light source in the array is configured to emit a divergent projection beam having a limited angular spread; and
a display layer disposed between the screen layer and the illumination layer, the display layer comprising:
a matrix of pixelets; and
a spacing region disposed between the pixelets in the matrix, wherein the array of light sources are positioned to emit the divergent projection beams having limited angular spread to project sub-images displayed by the pixelets as magnified sub-images on the backside of the screen layer, the magnified sub-images to combine to form the unified image that is substantially seamless,
wherein the unified images from each tileable display combine to form an overall-image displayed by the multi-panel display.

16. The multi-panel display of claim 15, wherein each light source in the array of light sources has a one-to-one correspondence with a corresponding pixelet in the matrix of pixelets.

17. The multi-panel display of claim 16, wherein each light source in the array is centered under its corresponding pixelet.

18. The multi-panel display of claim 15, wherein each pixelet in the matrix is positioned to receive its divergent projection beam having limited angular spread from a corresponding light source in the array of light sources, but not positioned to receive the divergent projection beams directly from the light sources in the array of light sources that are other than the corresponding light source.

19. The multi-panel display of claim 15, wherein the magnified sub-images on the backside of the display layer combine laterally to form the unified image.

20. The multi-panel display of claim 15, wherein additional optics are disposed over the light sources in the array of light sources to define the limited angular spread of the divergent projection beam.
